(19) United States
(12) Patent Application Publication
(10) Pub. No.: US 2019/0377996 A1
(43) Pub. Date: Dec. 12, 2019

(54) METHOD, DEVICE AND COMPUTER PROGRAM FOR ANALYZING DATA

(71) Applicant: RIIID INC., Seoul (KR)

(72) Inventors: Yeong Min CHA, Gyeonggi-do (KR); Jae We HEO, Seoul (KR); Young Jun JANG, Seoul (KR)

(21) Appl. No.: 16/488,221

(22) PCT Filed: Jun. 7, 2017
(86) PCT No.: PCT/KR2017/005919

§ 371 Date: Aug. 22, 2019

(30) Foreign Application Priority Data
May 19, 2017 (KR) 10-2017-0062549

(51) Int. Cl. G06N 3/00; G06N 20/00; G06N 7/00; G06F 16/2452

(52) U.S. Cl. CPC G06N 3/004; G06N 20/00; G06Q 50/205; G06F 16/24522; G06N 7/005

(57) ABSTRACT

The present invention relates to a method for establishing a diagnostic question set, of a data analysis framework, for a new user, the method comprising: step a of establishing a question database including a plurality of questions, of collecting solving result data of the user for the questions, and of applying the solving result data to the data analysis framework, thereby calculating modeling vector(s) of the questions and/or the user; step b of extracting, from the question database, at least one candidate question for establishing the diagnostic question set; step c of identifying a user for whom solving result data for the candidate question exist, and another question for which solving result data of the user exist; step d of applying only the solving result data of the user for the candidate question to the data analysis framework, thereby calculating a modeling vector of a virtual user; step e of applying the modeling vector of the virtual user, thereby calculating a virtual correct answer probability for the another question; and step f of comparing the virtual correct answer probability with the actual solving result data of the user for the another question, and averaging the comparison result according to the number of the users, thereby calculating a predicted probability for the candidate question.

### TECHNICAL FIELD

The present disclosure relates to a method for analyzing data and providing user-customized content, and more particularly, to a method and device for extracting a diagnostic question set optimized for new user analysis and labeling a data set to which a machine-learning framework is applied.

### BACKGROUND ART

Until now, educational content has generally been provided in packages. For example, there is a minimum of 700 questions per workbook on paper, and online or offline lectures are sold in batches, bundling an amount of study material appropriate for at least a month in units of 1 and 2 hours.

However, for students receiving education, there are differences as to individual weak subjects and weak question types, and therefore there is a need for personalized content rather than package-type content. This is because it is more efficient to study only the weak question types of one's own weak subjects than to solve all 700 questions in the workbook.

However, it is very difficult for students, who are learners, to identify their own weaknesses. Furthermore, since traditional educational institutions such as academies and publishers rely on subjective experience and intuition to analyze students and questions, it is not easy to provide optimized questions for individual students.

Thus, in the conventional education environment, it is not easy to provide personalized content in which the trainee can obtain the most efficient learning result, and the students lose the sense of accomplishment and interest in the package-type educational content.

### DETAILED DESCRIPTION OF THE INVENTION

### Technical Problem

Therefore, the present disclosure has been made in view of the above-mentioned problems, and an aspect of the present disclosure is to provide a method for efficiently extracting sample data necessary for user analysis. Further, another aspect of the present disclosure is to provide a labeling method for interpreting data analyzed by applying an unsupervised learning- or self-motivated learning-based machine-learning framework.

### Technical Solution

In accordance with an aspect of the present disclosure, a method for establishing a diagnostic question set, of a data analysis framework, for a new user, includes: step a of establishing a question database including a plurality of questions, of collecting solving result data of the user for the questions, and of applying the solving result data to the data analysis framework, thereby calculating modeling vector(s) of the questions and/or the user; step b of extracting, from the question database, at least one candidate question for establishing the diagnostic question set; step c of identifying a user for whom solving result data for the candidate question exists, and another question for which solving result data of the user exists; step d of applying only the solving result data of the user for the candidate question to the data analysis framework, thereby calculating a modeling vector of a virtual user; step e of applying the modeling vector of the virtual user, thereby calculating a virtual correct answer probability for the other question; and step f of comparing the virtual correct answer probability with the actual solving result data of the user for the other question, and of averaging the comparison result according to the number of the users, thereby calculating a predicted probability for the candidate question.

In accordance with another aspect of the present disclosure, a method for interpreting analysis results through a data analysis framework, includes: step a of establishing a question database including a plurality of questions, of collecting solving result data of a user for the questions, and of applying the solving result data to the data analysis framework, thereby forming at least one cluster for the questions and/or the user; step b of randomly extracting at least one piece of first data from the cluster and of selecting a first label for interpreting the first data; step c of assigning the first label to data having similarity within a threshold value range with the first data out of the data included in the cluster; step d of randomly extracting at least one piece of second data out of data having similarity outside the threshold value range with the first data and of selecting a second label for interpreting the second data; step e of assigning the second label to data having similarity within a threshold value with the second data out of the data included in the cluster; and step f of interpreting the cluster using the first label and the second label.

As described above, according to the present disclosure, there is an effect in that an optimized diagnostic question set necessary for analysis of a new user can be established.

Further, according to the embodiment of the present disclosure, there is an effect in that results analyzed by applying a machine-learning framework can be efficiently interpreted.

### BRIEF DESCRIPTION OF THE DRAWINGS

FIG. 1 is a flowchart illustrating a method for establishing a diagnostic question set for a new user in a data analysis framework according to an embodiment of the present disclosure; and

FIG. 2 is a flowchart illustrating a method for interpreting analysis results in an unsupervised learning-based data analysis framework according to an embodiment of the present disclosure.

### MODE FOR CARRYING OUT THE INVENTION

The present disclosure is not limited to the description of the embodiments described below, and it is obvious that various modifications can be made without departing from the technical gist of the present disclosure. In the following description, well-known functions or constructions are not described in detail since they would obscure the disclosure in unnecessary detail.

In the accompanying drawings, the same components are denoted by the same reference numerals. Further, in the accompanying drawings, some of the elements may be exaggerated, omitted or schematically illustrated. This is intended to clearly illustrate the gist of the present disclosure by omitting unnecessary explanations not related to the gist of the present disclosure.

Recently, as the spread of IT devices has expanded, data collection for user analysis has become easier. If the user data can be sufficiently collected, the analysis of the user becomes more precise, and content in the form most suitable for the user can be provided.

Along with this trend, there is a high demand for provision of user-customized educational content, especially in the education industry.

For a simple example, in a case in which a user has poor understanding of the concept of a verb tense when studying English, when questions containing the concept of “verb tense” can be recommend to the user, the learning efficiency will be higher. However, in order to provide such user-customized educational content, it is necessary to perform precise analysis of all content and individual users.

Conventionally, in order to analyze content and users, a method in which the concepts of corresponding subjects are manually defined by experts and the concepts of respective questions for the corresponding subject are individually determined and tagged by the experts has been used. Then, the learner's ability may be analyzed based on result information obtained by each user solving questions tagged for a specific concept.

However, this method has a problem in that the tag information depends on the subjectivity of a person. There is a problem in that the reliability of the result data cannot be high because tag information generated mathematically without intervention of subjectivity of a person is not mathematically assigned to the corresponding question.

Therefore, a data analysis server according to the embodiment of the present disclosure can exclude human intervention from a data-processing process by applying a machine-learning framework to learning data analysis.

Accordingly, a question solution result log of a user is collected, a multidimensional space composed of users and questions is formed, a value is assigned to the multidimensional space based on whether the answer of the user for a corresponding question is correct or incorrect, and a vector for each user and each question is calculated, thereby modeling the user and/or the question.

Further, using the user vector and/or the question vector, it is possible to mathematically determine the learning level of a specific user from all users, other users that can be clustered into a group similar to the learning level of the specific user, similarity between the specific user and the other users, the level of a specific question from all questions, other questions that can be clustered into a group similar to the specific question, similarity between the specific question and the other questions, and the like. Furthermore, it is possible to cluster users and questions on the basis of at least one attribute.

At this time, it should be noted that the present disclosure cannot be interpreted as being limited to what attributes or features the user vector and the question vectors include.

For example, according to the embodiment of the present disclosure, the user vector may include the degree to which the user understands an arbitrary concept, that is, an understanding of the concept. Further, the question vector may include what concepts the question is constituted of, that is, a concept composition diagram.

However, when learning data is analyzed by applying machine learning, there are some problems to be solved.

A first problem is about the processing when a new user or question is added.

In the case of a new user or question, analysis results cannot be provided until data for the user or question is accumulated. Therefore, it is necessary to efficiently collect learning result data required for deriving initial data, that is, initial analysis results, with certain reliability from a data analysis framework.

More specifically, question solving result data of the user is required to be accumulated to some extent in order to analyze the new user. Here, a problem of establishing a diagnostic question set for providing reliable analysis results must be solved.

Since reliable analysis results cannot be provided to a user for whom question solving result data is not accumulated to some extent, the user should solve diagnostic questions, and more precise analysis is possible along with an increase in the number of diagnostic questions. However, the user will prefer user-customized questions that can improve learning efficiency more quickly.

Accordingly, it is necessary to establish the minimum number of diagnostic questions that can secure the reliability of user analysis results in a certain range or more.

The present disclosure is intended to solve the above problems.

According to an embodiment of the present disclosure, it is possible to efficiently extract diagnostic questions for analyzing a new user. More specifically, it is possible to efficiently extract a question set that a new user has to solve in order to calculate an initial vector value of the new user who has no solving result data of a question database of a data analysis system, with arbitrary reliability.

Accordingly, the question set for user diagnosis may be efficiently established so that it is possible to provide a reliable analysis result without a user having to solve many questions in the corresponding system.

Meanwhile, when learning data is analyzed by applying machine learning, there may arise a problem of labeling for interpreting a result value, which is analyzed by applying machine learning, in a way that can be understood by a person.

When learning result data is modeled by applying a machine-learning framework without intervention of a person, that is, without a separate labeling process, there arises a problem in that it is impossible to identify what features are included in the modeled result. Furthermore, if users or questions are classified, the classification criteria are not determined. Therefore, there arises a problem in that the analysis result should be interpreted afterwards so that the user can understand the analysis result.

For example, when a specific user is analyzed as having attributes of a first classification, a second classification, and a third classification, it can be interpreted that the first classification indicates a low degree of understanding of gerunds, the second classification indicates a high degree of understanding of tenses, and the third classification has a medium score on TOEIC part 1. In this manner, the classification criteria should be interpreted to be understood by a person so that the learning level and weakness of the corresponding user can be explained.

However, when data is analyzed by applying the machine-learning framework of a so-called unsupervised learning method, it is difficult to determine the attributes by which the data is classified even when the result value is obtained.

The present disclosure is intended to solve the above problems.

According to an embodiment of the present disclosure, it is possible to provide a method of subsequently labeling results analyzed by the unsupervised learning-based machine learning in order to interpret the analyzed results in a way that can be understood by a person.

Accordingly, the subjectivity of a person may be excluded from a machine-learning process to extract pure data-based modeling results and to designate a label separately from the machine learning, thereby efficiently interpreting machine-learning results.

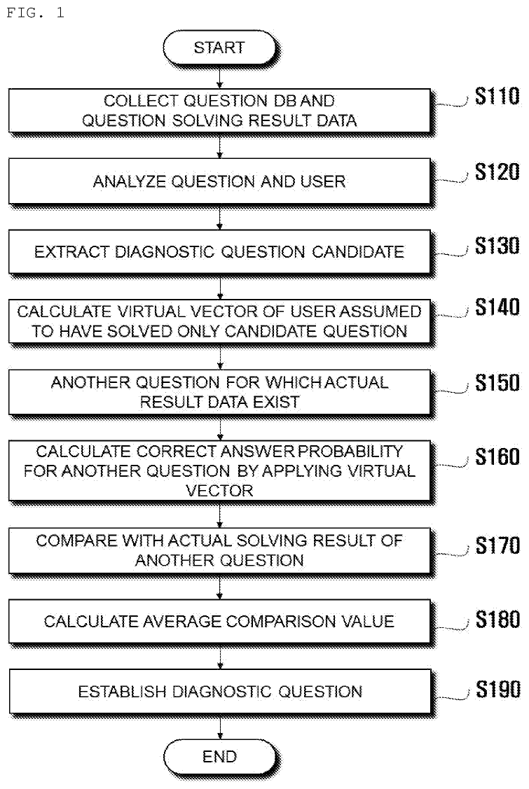

FIG. 1 is a flowchart illustrating a method of extracting a user diagnostic question set according to an embodiment of the present disclosure.

Operations 110 and 115 are prerequisites for extracting a new user diagnostic question set in a data analysis system.

According to the embodiment of the present disclosure, in operation 110, solving result data of all users for all questions may be collected.

More specifically, a data analysis server may establish a question database, and may collect the solving result data of all users for all questions belonging to the question database.

For example, the data analysis server may establish a database for various questions on the market, and may collect solving result data in a way that collects solution results of a corresponding user for corresponding questions. The question database includes listening test questions, which can be provided in the form of text, image, audio, and/or video.

At this time, the data analysis server can organize the collected question solving result data into a list of users, questions, and results. For example, Y (u, i) denotes a result obtained by solving a question i by a user u. Here, a value of “1” is given when the answer is correct, and a value of “0” is given when the answer is incorrect.

Further, in operation 115, the data analysis server according to the embodiment of the present disclosure may construct a multidimensional space composed of users and questions, and may assign values to the multidimensional space based on whether the answer of each user for a corresponding question is correct or incorrect, thereby calculating a vector for each user and the question. At this time, features included in the user vector and the question vector are not specified, and, for example, according to the embodiment of the present disclosure, the features can be interpreted in accordance with a method to be described later with reference to FIG. 3.

Next, in operation 120, the data analysis server may estimate the probability that the answer of a random user for a random question is correct, that is, a correct answer probability, using the user vector and the question vector.

At this time, the correct answer probability may be calculated by applying various algorithms to the user vector and the question vector, and the algorithm for calculating the correct answer probability in interpreting the present disclosure is not limited.

For example, the data analysis server may calculate a correct answer probability of a user for a corresponding question by applying a sigmoid function that sets parameters in a vector value of the user and a vector value of the question to estimate the correct answer probability.

As another example, the data analysis server may estimate a degree of understanding of a specific user for a specific question using the vector value of the user and the vector value of the question, and may estimate the probability that the answer of the specific user for the specific question will be correct using the estimated degree of understanding.

For example, if values of a first row of a user vector are [0, 0, 1, 0.5, 1], it can be interpreted that a first user does not understand the first and second concepts at all, completely understands the third and fifth concepts, and partially understands the fourth concept.

Further, if values of a first row of a question vector are [0, 0.2, 0.5, 0.3, 0], it can be interpreted that the first question does not include a first concept at all, includes a second concept by about 20%, includes a third concept by about 50%, and includes a fourth concept by about 30%.

At this time, when estimating the degree of understanding of the first user for the first question, it can be calculated as 0×0+0×0.2+1×0.5+0.5×0.5+1×0=0.75. That is, the first user may be estimated to understand the first question by 75%.

However, the degree of understanding of a user for a specific question and the probability that the answer of the user for the specific question will be correct are not the same. In the above example, assuming that the first user understands the first question by 75%, when the first user actually solves the first question, it is necessary to calculate the probability that the answer of the first user for the first question will be correct.

To this end, the methodology used in psychology, cognitive science, pedagogy, and the like may be introduced to estimate a relationship between the degree of understanding and the correct answer probability. For example, the degree of understanding and the correct answer probability can be estimated in consideration of multidimensional two-parameter logistic (M2PL) latent trait model, devised by Reckase and McKinley, or the like.

However, according to the present disclosure, it is sufficient to calculate a correct answer probability of a user for a specific question by applying the conventional technique, capable of estimating the relationship between the degree of understanding and the correct answer probability, in a reasonable way. It should be noted that the present disclosure cannot be construed as being limited to a methodology for estimating the relationship between the degree of understanding and the correct answer probability.

Next, in operation 120, the data analysis server may randomly extract at least one candidate question from the question database in order to establish the diagnostic question set for the new user.

Next, the data analysis server may identify a user for whom solving result data for the candidate question exists, and may calculate a virtual vector value for the user assuming that the user has solved only the candidate question. The virtual vector value may be calculated, for example, as the probability that the answer of a user, for whom only solving result data for the candidate question exists, for each question in the question database is correct in operations 130 and 140. The virtual vector value may be calculated in accordance with the reasonable prior art as well as the method described above in the description of operation 110.

For example, in the case in which a first question is extracted as a diagnostic candidate question in the question database, when users who have solved the first question are a user 1, a user 2, and a user 3 among all users, wherein the answer of the user 1 for the first question is correct, the answer of the user 2 for the first question is correct, and the answer of the user 3 for the first question is incorrect, the data analysis server may identify input values of (user, question, val) as (1, 1, 1), (2, 1, 1), and (3, 1, 0). Here, assuming that only the input values of (1, 1, 1), (2, 1, 1), and (3, 1, 0) exist, the data analysis server may calculate the probability that the answer of each of the users 1, 2, and 3 for another question is correct.

This serves to determine how much a correct answer probability for the other question matches the actual result in the same analysis framework when only solving result data of a new user for the candidate question exists, assuming that the user is a new user and that the new user has solved only the candidate question.

In other words, this serves to extract the diagnostic question in such a manner that the correct answer probability for the other question estimated through the corresponding question matches the result obtained by actually solving the other question.

Thus, in operations 160 and 170, the data analysis server may identify another question that the user, who has solved the candidate question, has actually solved, may calculate a correct answer probability of the other question by applying the virtual vector value, and may compare the calculated correct answer probability with the actual solution result.

In the above example, it is assumed that the user 1 has actually solved the first question, the third question, and the fifth question, wherein the answer of the user 1 for the first question is correct (1, 1, 1), the answer of the user 1 for the third question is incorrect (1, 3, 0), and the answer of the user 1 for the fifth question is correct (1, 5, 1). At this time, when correct answer probabilities of a virtual user u for the third question and the fifth question, calculated only using the input value of (1, 1, 1), that is, correct answer probabilities for the third question and the fifth question, calculated by applying a virtual vector value, are 0.4 and 0.6, respectively, a difference with the actual solution result may be calculated as being 0.6 for the third question and 0.4 for the fifth question, respectively.

Next, in operation 180, the data analysis server may average differences between the correct answer probability for the other question estimated through the candidate question and the actual value. More specifically, for all other users for whom solving result data for the candidate question exists, the data analysis server may average differences between the correct answer probabilities for questions that the other users have actually solved with the actual value. In the present disclosure, this can be referred to as an average comparison value of the diagnostic question candidate.

In the above example, it is assumed that the user 1 has actually solved the first, third, and fifth questions, the user 2 has actually solved the first and second questions, and the user 3 has actually solved the fourth and fifth questions. Here, the data analysis server according to the embodiment of the present disclosure may calculate a difference between a correct answer probability for the third and fifth questions and an actual solution result value of the user 1 for the third and fifth questions, assuming that only the input value (1, 1, 1) exists, a difference between a correct answer probability for the second question and an actual solution result value of the user 2 for the second question, assuming that only the input value (2, 1, 1) exists, and a difference between a correct answer probability for the fourth and fifth questions and an actual solution result value of the user 3 for the fourth and fifth questions, assuming that only the input value (3, 1, 0) exists.

Next, the data analysis server may average differences of the above-mentioned result values for the first question, which is the candidate question, with respect to each of the questions 2, 3, 4, and 5.

In operation 190, the data analysis server may set each of the questions existing in the question database as diagnostic question candidates, may calculate an average comparison value of the corresponding candidate question, and may establish diagnostic questions using the average comparison value.

For example, the data analysis server may set all of the questions in the question database as diagnostic candidates one by one, may calculate each average comparison value to arrange diagnostic question candidates in the order of the smallest average comparison value, and may extract a random set from the arranged diagnostic question candidates, thereby generating a diagnostic question set.

As another example, the data analysis server may set a plurality of questions, which are randomly extracted in a predetermined number of questions from the question database, as a diagnostic question candidate set, may calculate an average comparison value of each diagnostic question candidate constituting each set to calculate a representative average comparison value of the diagnostic question candidate set, and may finally determine the diagnostic question candidate set in which the representative average comparison value is within a predetermined range, as the diagnostic question set.

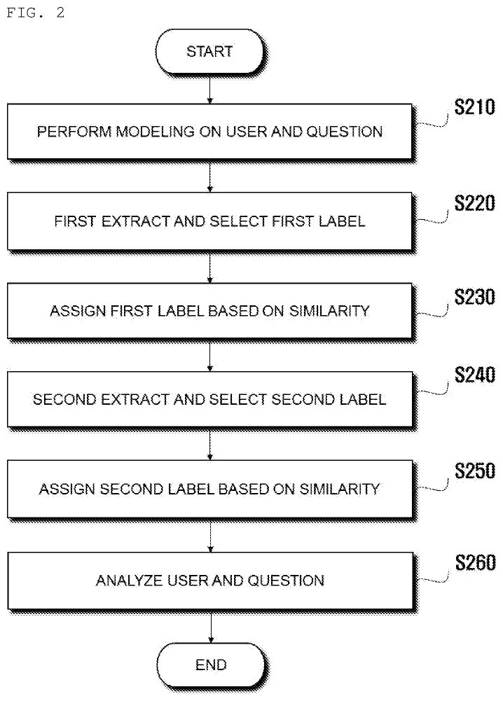

FIG. 2 is a flowchart illustrating a method for interpreting data analysis results by applying a machine-learning framework according to an embodiment of the present disclosure.

In operation 310, the data analysis server may apply the machine-learning framework to user's question solving result data to model the user and/or questions.

For example, the data analysis server according to the embodiment of the present disclosure may generate a modeling vector using only user's solution results without separate labeling on the question and the user, based on a so-called unsupervised learning-based machine-learning framework.

Further, the data analysis server may calculate the similarity of collected users' question solving result data on the basis of a distance between the data or probability distribution, and may classify the users and/or the questions in which the similarity is within a threshold value.

As another example, the data analysis server according to the embodiment of the present disclosure may generate a vector for each of all users and all questions based on the collected user's question solving result data, and may classify the users or the questions on the basis of at least one attribute.

However, at this time, there is no separate label for the user vector and the question vector generated by applying the machine-learning framework, and it is difficult to interpret what kind of attribute the vector contains or the attributes by which the questions and the users are classified.

Accordingly, the data analysis framework according to the embodiment of the present disclosure proposes a method for subsequently labeling and analyzing data analysis results through machine learning. It should be noted that the labeling according to the embodiment of the present disclosure is not applied in the machine-learning process but is given to interpret results after machine learning is terminated, that is, results obtained through the machine learning.

The data analysis framework according to the embodiment of the present disclosure may randomly extract at least one question or user from question or user data represented by a modeling vector, may randomly assign at least one label for interpreting the extracted question or user in operation 220, and may index the label to the corresponding question or user in operation 230.

The label may be, for example, indexing information of metadata composed of a concept or a theme for a specific subject in a tree format. The concept or theme may be given by an expert, but the present disclosure is not limited thereto.

Although not shown separately in FIG. 2, the data analysis server may generate a metadata set for minimum learning elements by arranging the learning element and/or the theme of the corresponding subject in a tree structure for label generation, and may classify the minimum learning elements into a group unit suitable for analysis.

For example, when first themes of a specific subject A are classified into A1-A2-A3-A4-A5 . . . , detailed themes of the first theme A1 as second themes are classified into A11-A12-A13-A14-A15 . . . , detailed themes of the second theme A11 as third themes are classified into A111-A112-A113-A114-A115 . . . , and detailed themes of the third theme A111 as fourth themes are classified in the same manner, the themes of the corresponding subject may be arranged in a tree structure.

The minimum learning elements of this tree structure can be managed for each analysis group, which is a unit suitable for analysis of users and/or questions. This is because it is more appropriate to set the label for interpreting the user and/or the question in a predetermined group unit suitable for analysis rather than setting the label in a minimum unit of learning elements.

For example, in the case in which the minimum unit for classifying learning elements of an English subject in a tree structure is composed of {verb-tense, verb-tense-past-perfect-progressive, verb-tense-present-perfect-progressive, verb-tense-future-perfect-progressive, verb-tense-past-perfect, verb-tense-present-perfect, verb-tense-future-perfect, verb-tense-past-progressive, verb-tense-present-progressive, verb-tense-future-perfect, verb-tense-past-progressive, verb-tense-present-progressive, verb-tense-future-progressive, verb-tense-past, verb-tense-present, verb-tense-future}, when analyzing user's weakness for each of <verb-tense>, <verb-tense-past-perfect-progressive>, <verb-tense-present-perfect-progressive>, and <verb-tense-future-perfect-progressive>, which are minimum units of the learning elements, it is difficult to derive meaningful analysis results due to the excessive segmentation.

This is because it cannot be said that a student who does not know past perfect progressive knows present perfect progressive, because learning proceeds in a comprehensive and holistic way under a specific category. Therefore, according to the embodiment of the present disclosure, the minimum unit of the learning elements can be managed for each analysis group, which is a unit suitable for analysis, and information about the analysis group can be used as a label for explaining the extracted question.

For example, the data analysis server may randomly extract at least one question from a cluster, and may assign a label capable of explaining the intention of the question to the extracted question.

Next, in operation 230, the data analysis server may classify the entire question data based on a first label assigned to a first extracted question.

For example, when the first label is assigned to a first question, which is extracted first, the data analysis server may classify questions within a threshold value range and questions outside the threshold value range based on similarity with the first question.

Further, the data analysis server may assign the first label to questions having similarity within the threshold value range with the first question.

Next, the data analysis server may randomly extract at least one question among questions having similarity outside the threshold value range with the first question in operation 240, may select a second label for interpreting a second extracted question, and may assign the second label to the second extracted question and other questions having similarity within a threshold value range with the second extracted question in operation 250.

In this case, the first label may be assigned to questions similar to the first extracted question and the second label may be assigned to questions similar to the second extracted question. The first label and the second label may be assigned to questions similar to the second extracted question as well as the first extracted question.

In this manner, when the label assignment is repeated with respect to the questions in this manner, all the questions may be classified in operation 260.

For example, when a first label for <verb-tense>, a second label for <type of verb>, and a third label for <active and passive> are assigned to a specific question, and ratios of the respective labels are 75%, 5%, and 20%, the corresponding question may be interpreted using the first label and the third label.

For example, the corresponding question can be interpreted as having <verb-tense> as the intention thereof and as including an incorrect answer view for <active and passive>.

Further, when the same first label, second label, and third label as those described above are assigned to a user, it can be interpreted that the degree of understanding of the user for <verb-tense> and <active and passive> is estimated as being 75% and 20%, respectively.

The embodiments of the present disclosure disclosed in the present specification and drawings are intended to be illustrative only and not for limiting the scope of the present disclosure. It will be apparent to those skilled in the art that other modifications based on the technical idea of the present disclosure are possible in addition to the embodiments disclosed herein.

1. A method for establishing a diagnostic question set of a data analysis framework for a new user, the method comprising:
step a of establishing a question database including a plurality of questions, of collecting solving result data of the user for the questions, and of applying the solving result data to the data analysis framework, thereby calculating modeling vector(s) of the questions and/or the user;
step b of extracting, from the question database, at least one candidate question for establishing the diagnostic question set;
step c of identifying a user for whom solving result data for the candidate question exists, and another question for which solving result data of the user exists;
step d of applying only the solving result data of the user for the candidate question to the data analysis framework, thereby calculating a modeling vector of a virtual user;
step e of applying the modeling vector of the virtual user, thereby calculating a virtual correct answer probability for the other question; and
step f of comparing the virtual correct answer probability with the actual solving result data of the user for the other question, and of averaging the comparison result according to the number of the users, thereby calculating a predicted probability for the candidate question.

2. The method as claimed in claim 1, further comprising:
establishing candidate questions for which the predicted probability is within a threshold value as the diagnostic question set.

3. A method for interpreting analysis results through an unsupervised learning-based data analysis framework, the method comprising:
step a of establishing a question database including a plurality of questions, of collecting solving result data of a user for the questions, and of applying the solving result data to the data analysis framework, thereby forming at least one cluster for the questions and/or the user;
step b of randomly extracting at least one piece of first data from the cluster and of selecting a first label for interpreting the first data;
step c of assigning the first label to data having similarity within a threshold value range with the first data out of the data included in the cluster;
step d of randomly extracting at least one piece of second data out of data having similarity outside the threshold value range with the first data and of selecting a second label for interpreting the second data;
step e of assigning the second label to data having similarity within a threshold value with the second data out of the data included in the cluster; and
step f of interpreting the cluster using the first label and the second label.

4. The method as claimed in claim 3, further comprising:
arranging learning elements of a specific subject in a tree structure to generate a metadata set for the learning elements of the subject;
classifying the learning elements in an analysis group unit to generate indexing information of the metadata; and
utilizing the indexing information of the metadata as the first label and the second label.
